(19) United States
(12) Patent Application Publication
(10) Pub. No.: US 2014/0174649 A1
(43) Pub. Date: Jun. 26, 2014

(54) SURFACE TREATMENT BY CHLORINATED PLASMA IN A BONDING METHOD

(71) Applicant: COMMISSARIAT A L'ENERGIE ATOMIQUE ET AUX ENERGIES ALTERNATIVES, Paris (FR)

(72) Inventor: Claire AGRAFFEIL, Grenoble (FR)

(73) Assignee: COMMISSARIAT A L'ENERGIE ATOMIQUE ET AUX ENERGIES ALTERNATIVES, Paris (FR)

(21) Appl. No.: 14/134,503

(22) Filed: Dec. 19, 2013

(30) Foreign Application Priority Data
Dec. 26, 2012 (FR) 1203592

(51) Int. Cl. B32B 38/00

(52) U.S. Cl. CPC B32B 38/0008
USPC 156/272.6

(57) ABSTRACT

The bonding method of two silicon-based surfaces includes the steps of:
subjecting at least one of the surfaces to surface activation treatment by means of an oxygen plasma comprising chlorine, the dilution percentage by volume of the chlorine in the oxygen of the plasma being from 0.25 to 10%, preferably from 1 to 3%,
placing the treated surfaces in contact.

### BACKGROUND OF THE INVENTION

The invention relates to a method for direct bonding of two silicon-based surfaces.

### STATE OF THE ART

The principle of bonding by molecular bonding or direct bonding is based on bringing two surfaces into direct contact without using a specific material such as an adhesive, a wax, a metal with a low melting temperature, etc.

Direct bondings are generally performed at ambient temperature and pressure after chemical cleaning of the surfaces. However, such bondings present low bonding energies, which often have to be reinforced by subsequent heat treatment. Thus, to obtain bonding energies of about 5 J/m², it is necessary to have recourse to heat treatment at high temperature, typically of about 1000° C. However in a very large number of applications, heat treatments at such a temperature are not admissible.

Bonding methods not requiring high-temperature heat treatment have already been proposed. They generally comprise a surface activation step requiring very particular operating conditions, which are often difficult to implement.

For example, U. Gösele et al. (“Self-propagating room-temperature silicon wafer bonding in ultrahigh vacuum”, Appl. Phys. Lett. 1995, 67: 3614) studied the effects of surface activation treatment of silicon by means of an argon plasma. Such a treatment enables direct bonding of silicon wafers presenting high bonding energies. However, such a method has to be performed in an ultra-vacuum (3*10⁻⁹ Torr). Specific equipment is therefore indispensable to implement bonding according to U. Gösele et al.

C. Wang and T. Suga (“Room-temperature direct bonding using fluorine containing plasma activation”, J. Electrochem. Soc. 2011, 158(5):H529) sought to remedy the drawbacks of bonding methods of the prior art. They thus described a direct bonding method at ambient temperature and pressure comprising a surface activation step by means of a O₂/CF₄ plasma followed by a step of placing the treated surfaces in contact. The O₂/CF₄ activation method is performed in a standard reactor of RIE type and allows high bonding energies between two silicon surfaces. However, this method does not enable defect-free bonding to be obtained directly and implies at least two additional steps.

First of all, once the surfaces have been activated and before they are brought into contact, the surfaces have to be maintained under controlled temperature and humidity conditions in order to prepare the bonding. The substrates are thus arranged on a heating plate in a moist atmosphere in order to obtain a specific relative moisture content of the surface of the substrate. After the surfaces have been brought into contact, a “cold rolling” step is also described. This step consists in applying a pressure on the two substrates to be bonded in order to reduce the number of defects present at the level of the bonding interface.

### OBJECT OF THE INVENTION

The object of the invention is to provide a method for performing direct bonding of two silicon-based surfaces that is able to be implemented at ambient temperature and enabling a substantially defect-free bonding interface to be obtained presenting a high bonding energy compared with methods of the prior art, without an additional subsequent heat treatment step at high temperature, for example at a temperature of about 500° or even 1000° C. The bonding method in addition does not require any additional conditioning step of the surfaces under particular humidity and temperature conditions after activation and before bonding or even a “cold rolling” step after the surfaces have been placed in contact.

According to the invention, this object is achieved by the fact that, before the silicon-based surfaces are placed in contact, at least one of said surfaces is subjected to surface activation treatment by means of an oxygen plasma comprising chlorine, the dilution percentage by volume of the chlorine in the oxygen of the plasma being from 0.25 to 10%, preferably between 1 and 3%.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 represents the infrared spectrum of a O₂/CF₄ bonding of two silicon-based surfaces according to the prior art without a conditioning step of the surfaces controlling the relative moisture content of the surfaces before bonding or cold rolling;

FIG. 2 represents the infrared spectrum of a O₂/HBr/Cl₂ bonding of two silicon-based surfaces according to a particular embodiment of the invention.

### DESCRIPTION OF PARTICULAR EMBODIMENTS

The invention relates to a method for direct bonding of two silicon-based surfaces, advantageously performed at ambient temperature. The method comprises the following successive steps:
subjecting at least one of the surfaces to surface activation treatment by means of an oxygen plasma comprising chlorine, the dilution percentage by volume of the chlorine in the oxygen being from 0.25 to 10%, preferably between 1 to 3%,
placing the surfaces in contact.

What is meant by “silicon-based surfaces” are surfaces one of the constituents of which, generally the major constituent, is silicon. Said surfaces are preferably chosen from silicon, silicon oxide, silicon-germanium, silicon oxycarbide and silicon nitride surfaces. They present a roughness of typically less than a nanometre, preferably less than 0.5 nm, even more preferably comprised between 0.15 and 0.5 nm. The roughness values are measured by AFM tip on 1 μm×1 μm fields.

What is meant by “ambient temperature” is a temperature of 25±5° C. What is meant by “ambient pressure” is a pressure of about 1013.25 hPa.

The silicon-based surface can be obtained by any means known to the person skilled in the art. The silicon can be in amorphous, single-crystal or polycrystalline form. According to one embodiment, deposition of the material forming the silicon-based surface can be performed by PECVD (Plasma-Enhanced Chemical Vapor Deposition) or by PVD (Physical Vapor Deposition) on a suitable substrate. The substrate is advantageously made from LiNbO₃ or from quartz.

The bonding method comprises at least one activation treatment consisting in exposing at least one of the two surfaces to an oxygen plasma comprising chlorine. What is meant by oxygen plasma is a plasma comprising a volume of oxygen of at least 75%, preferably 80%, more preferably 90% and even more preferably 95%. Other gases than oxygen can be present in the oxygen plasma in small quantities, i.e. at a concentration of about a few percent of volume, and more particularly less than 5%. The dilution percentage by volume of the chlorine in the oxygen of the plasma is from 0.25 to 10%, preferably between 1 to 3%. The chlorine can be added in different forms. It can in particular be any compound chosen from Cl₂, BCl₃, HCl, SiCl₄ and mixtures thereof. The dilution percentage is measured by comparing the volume of the chlorinated precursor considered as being pure with respect to the volume of oxygenated precursor.

Surface activation treatment of silicon-based surfaces enables a superficial layer of silicon oxide containing chlorine to be created at the surface of the substrates. Advantageously, the superficial layer of silicon oxide containing chlorine presents a thickness comprised between 1 and 5 nm.

The superficial layer of silicon oxide containing chlorine obtained by means of the surface activation treatment presents the property of being hydrophilic. It typically presents a contact angle for a water drop of less than 25°, preferably comprised between 15 and 20°.

According to a particular embodiment, in addition to oxygen and chlorine, the plasma of the surface activation treatment comprises bromine, argon, nitrogen, fluorine or a mixture thereof. The plasma can therefore be constituted by oxygen and chlorine. It can also be constituted by oxygen, chlorine and bromine. It can further be constituted by oxygen and chlorine and at least one of the constituents chosen from argon, bromine, nitrogen and fluorine.

According to a preferred embodiment, in particular when the surfaces to be bonded are silicon oxide-based, more particularly SiO₂-based, the plasma of the surface activation treatment comprises oxygen, chlorine and bromine, the dilution percentage by volume of the bromine in the oxygen of the plasma being from 0.25 to 10%, preferably from 2 to 5%. The bromine is preferably added in the form of HBr. The dilution percentage by volume of the bromine in the oxygen of the plasma is measured by comparing the volume of the bromine precursor considered as being pure with respect to the volume of oxygenated precursor.

According to a particular embodiment, the surface activation treatment is performed at a pressure of 5 to 200 mT, preferably of 30 to 80 mT, even more preferably of 50 to 70 mT.

According to an embodiment that is compatible with the previous embodiments, the plasma of the surface activation treatment is generated by a source with a power of 200 to 1000 W, preferably from 300 to 500 W.

Advantageously, the duration of the surface activation treatment is comprised between 10 and 120 seconds, preferably between 20 and 40 seconds.

According to a particularly preferred embodiment, the plasma of the surface activation treatment is generated by a source with a power of 200 to 1000 W, preferably from 300 to 500 W, said treatment presenting a duration comprised between 10 and 120 seconds, preferably comprised between 20 and 40 seconds.

Following the surface activation treatment, the treated surfaces are placed in contact, for example manually, at ambient temperature and pressure. A slight localized pressure can be applied for example by means of a stylus to initiate the bonding. The bonding wave then propagates in spontaneous and homogenous manner to the whole of the assembled structure forming a substantially defect-free bonding interface, without it being necessary to apply any additional pressure.

According to one embodiment and prior to the surface activation treatment, at least one silicon-based surface is subjected to surface oxidation treatment by means of an oxygen plasma devoid of chlorine. The oxidation treatment generates a silicon oxide at the surface of the silicon-based layer with a thickness of about 0.25 to 10 nm, typically with a thickness between 1 and 5 nm. The silicon oxide in particular has the purpose of performing protection of the silicon-based surface with a view to the subsequent activation step, in particular when the plasma contains a high quantity of chlorine. Indeed, under certain conditions, chlorine, when it is present in a large quantity, in particular if its percentage is greater than 1% by volume in the oxygen of the plasma, can impair the silicon-based surface by etching the silicon that is present.

According to a particular embodiment, the surface oxidation treatment is performed at a pressure of 5 to 200 mT, preferably of 30 to 80 mT, even more preferably of 50 to 70 mT.

According to an embodiment that is compatible with the foregoing embodiments, the plasma of the surface oxidation treatment is generated by a source with a power of 200 to 1000 W, preferably from 300 to 500 W.

Advantageously, the duration of the surface oxidation treatment is comprised between 5 and 60 seconds, preferably between 20 and 40 seconds.

According to a particularly preferential embodiment, the plasma of the surface oxidation treatment is generated by a source with a power of 200 to 1000 W, preferably of 300 to 500 W, said treatment presenting a duration comprised between 5 and 60 seconds, preferably between 20 and 40 seconds.

The plasmas of the surface treatments are generated by any means known to the person skilled in the art. Advantageously, they are generated by an Inductively Coupled Plasma (ICP) source or a source with capacitive coupling (RIE or Reactive Ion Etching).

When the activation treatment is performed, only one of the two surfaces can be treated. When both the surfaces are treated, they can be exposed simultaneously or successively to the oxygen plasma comprising chlorine. In the case of successive exposures, the conditions of the surface treatment undergone by the two surfaces can be the same or different. Furthermore, exposure of the substrate or substrates to the plasma can be performed in one or more steps.

Likewise, when the oxidation treatment is performed, only one of the two surfaces can be treated. If both of the surfaces are treated, they can be exposed simultaneously or successively to the oxygen plasma. In the case of successive exposures, the conditions of the surface treatment undergone by the two surfaces can be the same or different. Furthermore, exposure of the substrate or substrates to the plasma can be performed in one or more steps.

In a specific embodiment, superficial oxide layers are formed at the surface of the silicon-based surfaces by wet process and in particular by a wet process cleaning step. Thus, prior to any surface treatment step, the surfaces are advantageously subjected to a cleaning step. Preferably, the cleaning step is a step of CARO type followed by cleaning of RCA type comprising a first phase of SC1 type and a second phase of SC2 type. The CARO cleaning is cleaning in an acid bath called CARO (H₂SO₄+H₂O₂). The first phase (SC1 or “Standard Cleaning 1”) and the second phase (SC2 or “Standard Cleaning 2”) of the RCA cleaning respectively consist in cleaning by means of an alkaline solution such as NH₄OH+H₂O₂+H₂O and in cleaning by means of a powerful oxidizing agent such as HCl+H₂O₂+H₂O. The surfaces cleaned in this way present the advantage of having a small quantity of defects after bonding.

However, at least one superficial oxide layer can be formed, prior to the surface activation treatment, by other techniques, either alone or in combination. It can for example be formed by thermal oxidation. It can also be formed by deposition such as chemical vapor deposition (CVD), ion beam sputtering (IBS) or by direct oxidation of the silicon surface by ICP or RIE.

The surface activation treatment step enabling to obtain hydrophilic silicon-based surfaces is followed by a step of placing the hydrophilic surfaces in contact. The step of placing in contact can be performed in situ, i.e. in the chamber where the surface treatment or treatments are performed. It is more generally performed ex situ. Furthermore, placing the surfaces in contact can be performed directly after the surface activation step, i.e. without an intermediate step between the two steps of surface activation and of placing in contact. In alternative embodiments, one or more intermediate steps can be performed between these two steps, for example to remove particles or possible contamination (metallic or hydrocarbon . . . ) deposited when the surface activation step is performed. These intermediate steps can for example comprise surface treatment steps that are chemical or conventionally used in the microelectronics field, for example one or more brushings.

In all cases, the additional steps, also noted intermediate steps, are performed in such a way as to preserve the hydrophilic nature of the surfaces having been subjected to the oxidation treatment and/or to the activation treatment.

According to a particular embodiment, a heat treatment step at a temperature of 80 to 200° C., preferably of 80 to 120° C., is performed after the step of placing the activated surfaces in contact. Advantageously, the heat treatment step is performed for a duration of 30 to 120 minutes, preferably of 45 minutes to 75 minutes. Such a step enables the same bonding energy between the silicon-based surfaces to be obtained more quickly. The same energy can indeed be obtained at ambient pressure and temperature after typically 24 hours.

In all cases, once the surfaces activated by means of an oxygen plasma comprising chlorine are brought into contact, the bonding interface presents a considerably smaller number of defects compared with bonding methods of the prior art, and is even defect-free. In particular, the surface does not comprise any bubbles. This interface further remains of good quality in time, even when the bonded structure undergoes a subsequent heat treatment step.

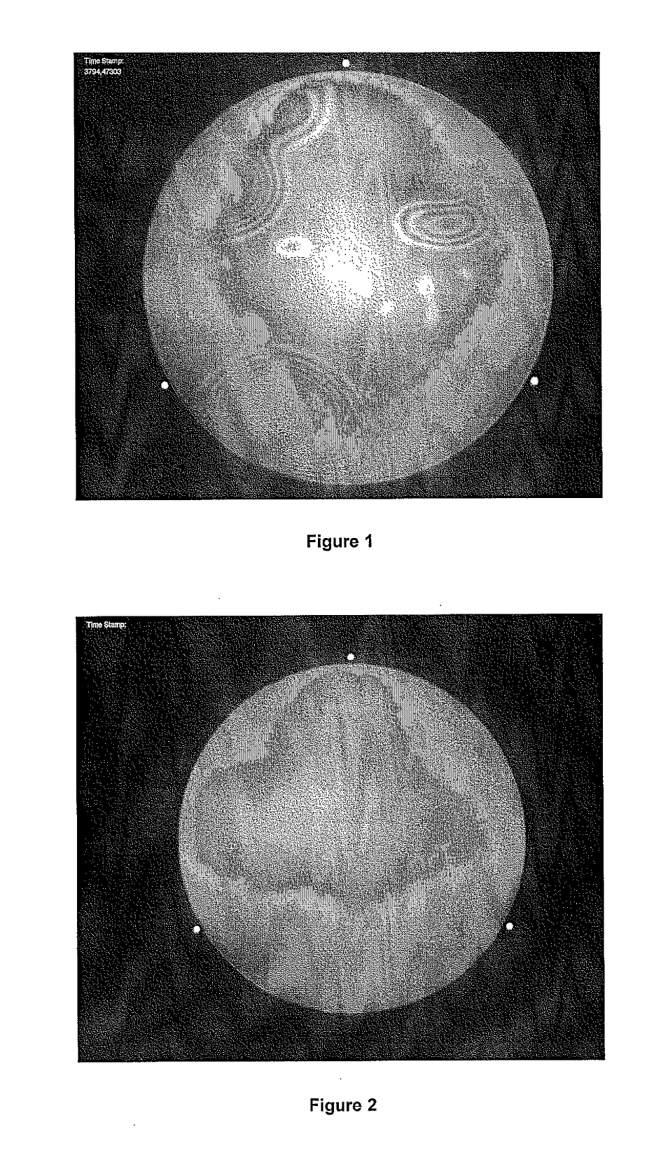

For example purposes, FIG. 1 represents the spectrum obtained by Fourier infrared spectroscopy (FTIR) of a O₂/CF₄ bonding of two silicon-based surfaces according to the operating mode described by C. Wang and T. Suga (“Investigation of fluorine containing plasma activation for room-temperature bonding of Si-based materials”, Microelectronics Reliability 2012, 52:347) but without a prior step of conditioning the moisture content of the surfaces before bonding. The infrared spectrum illustrated is obtained directly after the step of placing in contact without this step being followed by a cold rolling step. FIG. 2 represents the infrared spectrum (FTIR) of a O₂/HBr/Cl₂ bonding of two silicon-based surfaces according to an embodiment of the invention described in the following. The infrared spectrum is also obtained directly after the bonding step. Unlike bonding according to the prior art, direct bonding after surface activation treatment by means of an oxygen plasma containing chlorine enables a substantially defect-free bonding interface to be obtained.

In addition to a substantially defect-free bonding interface, the bonding method according to the invention enables high bonding energies to be obtained, i.e. more than 3 or even 5 J/m². Measurement of the bonding energy is evaluated according to the method described by C. Wang and T. Suga (“Room-temperature direct bonding using fluorine containing plasma activation”, J. Electrochem. Soc. 2011, 158(5):H529).

The bonding method according to the invention can advantageously be applied to bonding of wafers comprising a silicon-based free surface, said wafers comprising a device sensitive to heat treatment. The method can also advantageously enable bonding of heterostructures having very different thermal expansion coefficients (TEC). As examples of heterostructures with different TEC, the method enables LiNbO₃/silicon, quartz/silicon bondings presenting very high bonding energies (4 to 5 J/m²) to be performed at ambient temperature. In such cases, a layer of SiO₂ is deposited on the LiNbO₃ or quartz substrates. Deposition is preferably performed by PECVD thus forming a silicon-based surface on the substrates. Said SiO₂ surfaces advantageously present a thickness of 200 nm.

In the same way, the bonding method enables bonding of heterostructures comprising particularly heat-sensitive polymers to be performed. In such a case, deposition of the silicon-based surface is advantageously performed on the substrate at low temperature (compatible with the polymer) by PVD.

Other features and advantages will become apparent on reading of the non-restrictive examples described in the following.

### EXAMPLES

For illustration purposes, tests were performed with substrates comprising a silicon-based surface. The substrates present a thickness of 750 microns and a diameter of 200 mm. Examples 1 to 6 thus each correspond to a bonding method between two substrates each of which has been subjected to cleaning and to exposure in an oxygen plasma comprising chlorine, under various conditions, before being placed in contact. Before the plasma activation step, all the substrates were cleaned by means of CARO cleaning, followed by RCA cleaning (SC1 and SC2).

The enclosure in which the surface treatment is performed for examples 1 to 6 is an ICP device marketed by Applied Materials under the trade-name AMAT Centura DPS+.

### Example 1

### Bonding Method of Different Silicon-Based Surfaces

Three types of bonding were performed according to the composition of the silicon-based surfaces to be bonded: bonding of two silicon surfaces (Si/Si), of two SiO₂ surfaces (SiO₂/SiO₂), and of a first silicon surface with a second SiO₂ surface (Si/SiO₂).

The operating conditions to perform the bonding method are as follows:
The substrates comprising a silicon-based surface with a thickness of 145 nm are placed in an ICP enclosure having an inductive coupling plasma source comprising a radiofrequency power generator with a power that can be a few hundred watts and preferably between 500 W and 800 W.
Surface oxidation treatment is performed at ambient temperature, i.e. at 25±5° C., under a partial pressure of 60 mT for a duration of 30 seconds. The power of the plasma source is fixed at 800 W whereas the power of the bias is fixed at 20 W. The plasma is a pure oxygen plasma (flowrate: 100 sccm).
The oxidation treatment is directly followed by surface activation treatment. The activation treatment is performed at ambient temperature, i.e. at 25±5° C., under a partial pressure of 60 mT for a duration of 30 seconds. The power of the plasma source is fixed at 400 W whereas the power of the bias is fixed at 10 W. The plasma is an O₂ plasma (100 sccm)/Cl₂ (3 sccm). The dilution percentage by volume of the chlorine in the oxygen of the plasma is 3%.
The treated substrates are placed in contact manually and then stored under standard conditions for a few hours (25±5° C., atmospheric pressure, 30 to 60% relative humidity).

The bonding energies are evaluated according to the method described by C. Wang and T. Suga (“Room-temperature direct bonding using fluorine containing plasma activation”, J. Electrochem. Soc. 2011, 158(5):H529) after 12, 24, 35, 45 and 55 h of storage. The results obtained are presented in Table 1.

TABLE 1

Storage time (h)

| | | 12 | 24 | 36 | 48 |
|---|---|---|---|---|---|
| Bonding | Si/Si | 2.9 | 3.6 | 5 | 5 |
| energy | SiO₂/SiO₂ | 1.9 | 2.3 | 3.6 | 3.6 |
| (J/m²) | Si/SiO₂ | 3.2 | 4.1 | 4.6 | 4.6 |

After 36 h of storage, all the bondings present high bonding energies, i.e. more than 3 or even 4 J/m².

### Example 2

### Bonding Method Comprising or Not Comprising Surface Activation Treatment by Means of an Oxygen Plasma Devoid of Chlorine

The bondings are performed between two SiO₂ surfaces (SiO₂/SiO₂) with a thickness of 145 nm. A first bonding is performed, as in example 1, with surface oxidation treatment followed by surface activation treatment and placing of the treated surfaces in direct contact. A second bonding is performed without surface oxidation treatment, the cleaning step being immediately followed by surface activation treatment and placing of the treated surfaces in direct contact.

The operating conditions are the same as in example 1 with the exception of the pressure in the enclosure during the surface treatment step or steps which is 40 mT, i.e. about 0.1333 mPa.

The results obtained are presented in Table 2.

TABLE 2

Storage time (h)

| | | 12 | 24 | 36 | 48 |
|---|---|---|---|---|---|
| SiO₂/SiO₂ | With surface | 1.9 | 2.3 | 3.6 | 3.6 |
| | oxidation treatment | | | | |
| | Without surface | 1.2 | 1.3 | 1.3 | 1.5 |
| | oxidation treatment | | | | |

In the case of the SiO2/SiO2 bonding and for a pressure of 40 mT, the addition of a prior oxidation phase by plasma O₂ enables higher bonding energies to be achieved than in O₂/Cl₂ plasma alone.

### Example 3

### Bonding Method of Silicon Surfaces According to the Pressure when Performing Surface Treatments

The bondings are performed between two silicon surfaces (Si/Si).

The operating conditions are the same as those of example 1 with the exception of the pressure in the enclosure during the surface treatment steps which is either 40 mT or 60 mT.

The results obtained are presented in Table 3.

TABLE 3

Storage time (h)

| | | 12 | 24 | 36 | 48 |
|---|---|---|---|---|---|
| Bonding | 40 mT | 2.9 | 3.6 | 5 | 5 |
| energy | 60 mT | 3.8 | 4.9 | 5 | 5 |
| (J/m²) | | | | | |

In an ICP reactor, a pressure of 60 mT when the surface treatment steps are performed enables a bonding energy of 5 J/m² to be obtained after 24 h of storage whereas such a bonding energy is only obtained after 36 h of storage when the pressure during the surface treatment steps is 40 mT.

### Example 4

### Bonding Method of Silicon Surfaces According to the Powers of the Plasma Source and of the Bias During the Surface Treatment Operations

The bondings are performed between two silicon surfaces (Si/Si).

The operating conditions are the same as those of example 1 with the exception of the powers of the plasma source and of the bias during the surface treatments which are either 400 and 10 W respectively or 800 and 20 W respectively.

The results obtained are presented in Table 4.

TABLE 4

Storage time (h)

| | | 12 | 24 | 36 | 48 |
|---|---|---|---|---|---|
| Bonding | 400/10 W | 2.9 | 3.6 | 5 | 5 |
| energy | 800/20 W | 3.2 | 3.6 | 4.1 | 5 |
| (J/m²) | | | | | |

In an ICP reactor, the high powers of the plasma source and of the bias (respectively 800 and 20 W) when the surface treatment steps are performed enable a bonding energy of 5 J/m² to be obtained after storage of a longer time than when these same powers are lower (respectively 400 and 10W).

### Example 5

### Bonding Method of Silicon Surfaces According to the Dilution Percentage by Volume of the Chlorine in the Oxygen of the Plasma of the Surface Activation Treatment

The bondings are performed between two silicon surfaces (Si/Si).

The operating conditions are the same as those of example 1 with the exception of the dilution percentage by volume of the chlorine in the oxygen of the plasma of the surface activation treatment which is in one case 3% and in the other case 6%.

The results obtained are presented in Table 5.

TABLE 5

Storage time (h)

| | | 12 | 24 | 36 | 48 |
|---|---|---|---|---|---|
| Bonding | 3% | 2.9 | 3.6 | 5 | 5 |
| energy | 6% | 2.6 | 2.9 | 3.2 | 3.6 |
| (J/m²) | | | | | |

When bonding of two Si/Si surfaces is performed, the increase of the dilution percentage by volume of the chlorine in the oxygen of the plasma of the surface activation treatment from 3 to 6% does not enable the bonding energy to be improved.

### Example 6

### Bonding Method of Silicon Surfaces According to the Presence of Bromine in the Plasma of the Surface Activation Treatment

The bondings are performed between two SiO₂ surfaces (SiO₂/SiO₂) with a thickness of 145 nm.

In a first case, the operating conditions are the same as those of example 1 (O₂/Cl₂ plasma). In a second case (noted “O₂/HBr/Cl₂ plasma”), the operating conditions are the same as those of example 1 with the exception of the presence of HBr in the plasma of the activation treatment, the dilution percentage by volume of the bromine in the oxygen of the plasma being 4.55%.

The results obtained are presented in Table 6.

TABLE 6

Storage time (h)

| | | 12 | 24 | 36 | 48 |
|---|---|---|---|---|---|
| Bonding | O₂/Cl₂ | 1.9 | 2.3 | 3.6 | 3.6 |
| energy | plasma | | | | |
| (J/m²) | O₂/HBr/Cl₂ | 2.6 | 3.6 | — | 4.6 |
| | plasma | | | | |

When bonding of two SiO₂/SiO₂ surfaces is performed, the presence of bromine in the plasma of the surface activation treatment enables the bonding energy between the two surfaces in contact to be increased.

Furthermore, for all the bondings formed according to examples 1 to 6, analysis of the spectrum performed by Fourier transform infrared spectroscopy (FTIR) of a O₂/Cl₂ bonding of two silicon-based surfaces according to the operating mode described by C. Wang and T. Suga (“Room-temperature direct bonding using fluorine containing plasma activation”, J. Electrochem. Soc. 2011, 158(5):H529) revealed that substantially defect-free bonding interfaces were obtained.

Other tests were also performed in a RIE device. Activation treatment was performed at ambient temperature, i.e. at 25±5° C. under a partial pressure comprised between 40 mT and 200 mT for a duration comprised between 15 and 90 seconds. The power of the plasma source is fixed between 100 and 400 W. The dilution percentage by volume of the chlorine in the oxygen of the O₂/Cl₂ plasma was fixed between 0.25 and 10%. These tests also enabled substantially defect-free high-energy bondings to be obtained.

1. Bonding method of two silicon-based surfaces, comprising the following successive steps:
subjecting at least one of the surfaces to surface activation treatment by means of an oxygen plasma comprising chlorine, the dilution percentage by volume of the chlorine in the oxygen of the plasma being from 0.25 to 10%,
placing the treated surfaces in contact.

2. Method according to claim 1, wherein the surfaces are chosen from silicon, silicon oxides, silicon-germanium, silicon oxycarbide and silicon nitride.

3. Method according to claim 1, wherein, prior to the surface activation treatment, the surfaces are subjected to surface oxidation treatment by means of an oxygen plasma devoid of chlorine.

4. Method according to claim 1, wherein the plasma of the surface activation treatment comprises an additional gas chosen from bromine, argon, nitrogen, fluorine or a mixture thereof.

5. Method according to claim 4, wherein the plasma of the surface activation treatment comprises bromine, the dilution percentage by volume of the bromine in the oxygen of the plasma being from 0.25 to 10%.

6. Method according to claim 1, wherein at least one surface activation treatment is performed at a pressure of 5 to 200 mT.

7. Method according to claim 1, wherein the plasma of at least one surface activation treatment is generated by a source with a power of 200 to 1000 W.

8. Method according to claim 7, wherein the duration of the surface activation treatment is comprised between 10 and 120 seconds.

9. Method according to claim 1, wherein. after the treated surfaces have been placed in contact, it comprises a heat treatment step at a temperature of 80 to 200° C.

10. Method according to claim 9, wherein the heat treatment step is performed during a period of 30 to 120 minutes.
